(19) United States
(12) Patent Application Publication
(10) Pub. No.: US 2003/0004818 A1
(43) Pub. Date: Jan. 2, 2003

(54) Online postcard order and creation system

(76) Inventor: Stephen Hoffman, Encinitas, CA (US)

Correspondence Address: John R. Flanagan, FLANAGAN & FLANAGAN, P.O. Box 11300, Jackson Hole, WY, 83002, US

(21) Appl. No.: 09/893,656

(22) Filed: Jun. 28, 2001

(51) Int. Cl. G06F 17/60

(52) U.S. Cl. 705/26; 707/506

(57) ABSTRACT

An online postcard order and creation system includes an online site server, a user login subsystem for customers to create accounts and log into the online site server, a novice order creation subsystem for a logged-in customer who chooses to place an order and create a postcard online by selecting an image from a database in the server, selecting and previewing a layout of the postcard front and back, and entering customer order and billing details for the created postcard, a professional order creation subsystem for a logged-in customer who chooses to place an order and create a postcard by submitting press-ready artwork of the postcard and entering customer order and billing details for the created postcard, an order tracking subsystem for a customer to view the status of submitted orders, and an administrative control subsystem for internal staff to review customer orders and account data.

### BACKGROUND OF THE INVENTION

1. Field of the Invention

The present invention generally relates to online business models and, more particularly, is concerned with an online postcard order and creation system. The term “postcard” is used herein in a generic sense as inclusive of all types of printed cards.

2. Description of the Prior Art

Various systems are installed at commercial websites accessible on the Internet where customers can login and either furnish an electronic image and message or select one provided by the website. The electronic image and message are then employed by the system to create an electronic postcard, an e-card, for the customer. After the e-card is created, the customer then can have it transmitted over the Internet to a target party's e-mail address. One e-card creation system that is accessed through the Internet is disclosed in U.S. Pat. No. 6,018,774 to Mayle et al.

However, prior art systems do not permit the creation of postcards by utilizing printing industry standard four-color web offset printing from an original online order. Instead, current systems generate postcards at 72 dpi producing a low-resolution image that can be captured and e-mailed easily and even set to four-color printing, but the final product will still be a 72 dpi printed image. The quality of this image is viewed substandard in the printing industry.

Consequently, there is a need for an innovation that will overcome problems of prior art online systems for ordering and generating postcards without introducing new problems in place thereof.

### SUMMARY OF THE INVENTION

The present invention provides an online postcard order and creation system which satisfies the aforementioned needs. The online system of the present invention includes at least one and preferably both of two different online order creation subsystems for allowing online ordering and creating of postcards by novice customers and professional customers. The system also facilitates four-color web offset printing from an original online order at printing industry standards of the resolution and line screen of the image, such as 355 dpi and 245 line screen.

Accordingly, the present invention is directed to an online postcard order and creation system which comprises: (a) an online site server; (b) a user login subsystem by which a novice customer creates an account and logs into the online site server; (c) a novice order creation subsystem accessible and employed by a logged-in novice customer who chooses to place an order and create a postcard online by selecting an image from a database in the online site server having a library of offered images; and (d) an order tracking subsystem which is accessible by a customer to view the status of a submitted order. Furthermore, the novice customer further chooses to place the order and create the postcard online by selecting and previewing a layout of the postcard front and back and entering the customer order and billing details for the created postcard into the online site server.

The present invention also is directed to an online postcard order and creation system which comprises: (a) an online site server; (b) a user login subsystem by which a professional customer create an account and logs into the online site server; (c) a professional order creation subsystem accessible and employed by a logged-in customer who chooses to place an order and create the postcard by submitting press-ready artwork of the postcard; and (d) an order tracking subsystem which can be accessed by a professional customer to view the status of a submitted order. The press-ready artwork is submitted by the professional customer via File Transfer Protocol format. The professional customer further chooses to place an order and create the postcard by entering customer order and billing details for the created postcard into the online site server.

The online system further comprises an administrative control subsystem which allows internal staff to view, report and edit customer orders and account data stored in the online site server and employed in the operation of the order creation subsystems.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1 is a diagram of an online postcard order and creation system of the present invention.

FIG. 2 is a diagram of the sequence of stages involved in using a novice order creation subsystem of the online system.

FIG. 3 is a diagram of the sequence of stages involved in using a professional order creation subsystem of the online system.

### DETAILED DESCRIPTION OF THE INVENTION

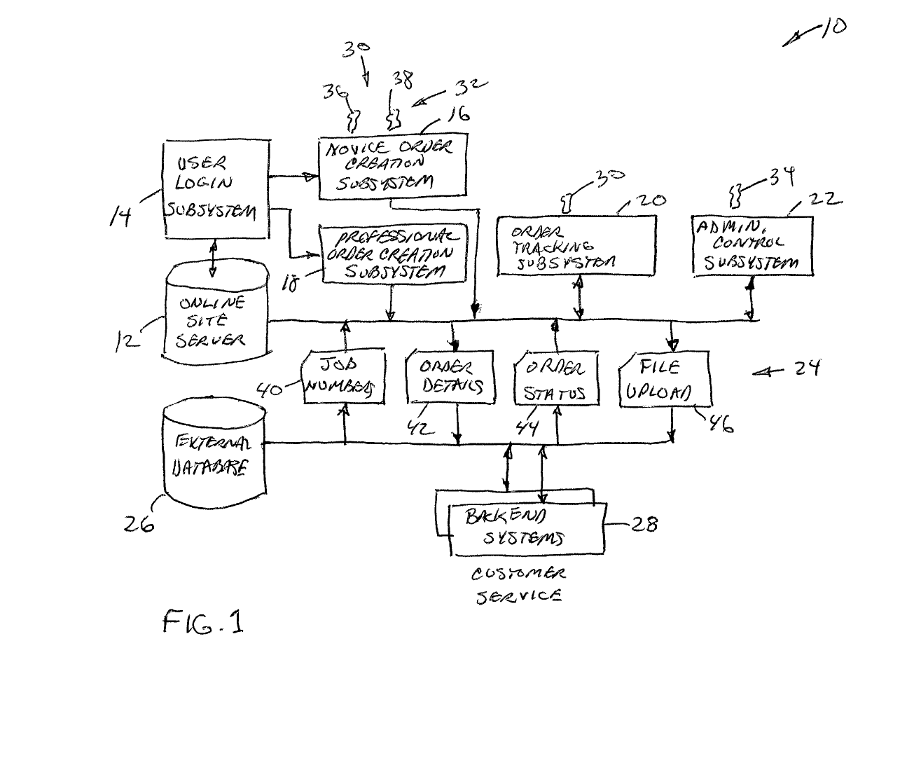

Referring to the drawings and particularly to FIG. 1, there is a diagram illustrating an online postcard order and creation system of the present invention, generally designated 10. The diagram illustrates the workflow relationship between components of the online system 10 and its interfaces. The online system 10 supports online order capturing and backend system interfacing. The various components of the online system 10 include an online site server 12, an user login subsystem 14, a novice order creation subsystem 16, a professional order creation subsystem 18, an order tracking subsystem 20, and an administrative control subsystem 22. The online system 10 further includes a plurality of interfaces 24 disposed between the aforementioned components and an external database 26 and backend systems 28.

Requirements of the online system 10 are defined in terms of a set of Actors and Use Cases involved in the online system 10. An actor is an entity external to the online system 10 that acts upon it and has requirements of the online system 10 in the form of the Use Cases. Actors are broken into two categories: the external backend systems 28 and users 30. Users 30 are customers 32 and an administrator 34. A customer 32 is a user who places an order with the online system 10 and, more specifically, may be a novice customer 36 or a professional customer 38. The novice customer 36 is one who has opened an online account and chooses to place an order using the novice order creation subsystem 16. The professional customer 38 is one who has opened an online account and chooses to place an order using the professional order creation subsystem 18. Both customers 32 use a conventional personal computer or the like and a conventional online service provider to access the online system 10 in a conventional manner via the Internet. Both customers 32 also use the user login subsystem 14 of the online system 10 to create an account and log onto the online site server 12. The administrator 34 is an authorized internal user with the need to report on orders and access customer information.

The interfaces 24 between the components of the online system 10 and the external database 26 and backend systems 28 are as follows: a job number import subsystem 40, an order details export subsystem 42, an order status import subsystem 44 and a file upload subsystem 46. In the operation of the job number import subsystem 40, a batch of job numbers is reserved and exported from the external database 26 to the online site server 12 for import and allocation to incoming orders by the online site server 12. In the operation of the order details export subsystem 42, order data is written to a delimited text file whenever an order is created by the online site server 12. Each order is written to a separate file, and these files are read into the external database 26 by a periodic batch process. In the operation of the order status import subsystem 44, order status updates are exported from the external database 26 hourly and read into the online site server 12 of the online system 10. In the operation of the file upload subsystem 46, files provided by the customer 32 are made available to the processes of the backend systems 28.

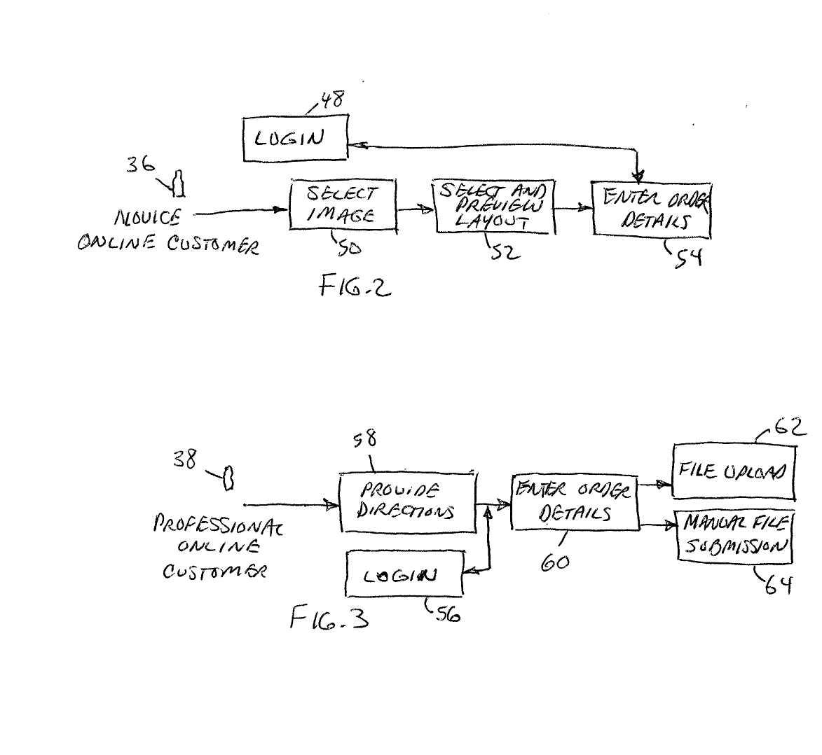

Referring to FIG. 2, there is illustrated a sequence of stages addressed by a novice customer 36 in using the novice order creation subsystem 16 of the online system 10. The novice customer 36 is required to login, as per block 48, on the user login subsystem 14 upon reaching and commencing the final step of the sequence. A visitor to the site of the online system 10 must login in order to identify their user session to the system 10 and complete the order creation process. The sequence of stages of the novice order creation subsystem 16 includes, first, select image, as per block 50, next, select and preview layout, as per block 52, and, finally, enter order details, as per block 54.

The user login, as per block 48, presents an initial screen to the user, offering the user the option of entering the username and password to an existing account, or alternatively electing to create a new account. If the user enters a username and password, and selects “Login”, these fields will be compared with existing accounts in the database of the online site server 12. If there is no matching existing account, the user will be warned that these details are incorrect, and is offered the alternative of either retrying or creating a new account. If the details match an existing account, this account is associated with this user for the duration of the session. If the user wishes to create a new account with the online system 10, the following information must be elicited from and submitted by the user: (1) desired username; (2) password and password verification; (3) email address; and (4) whether the user wishes to receiving mailings. Once submitted, the username is checked against the system database of the online site server 12 and rejected along with an error message if not unique. If accepted, the user account is created and the user logged into this account for the duration of this session.

When the user is successfully logged in, a page is displayed on the user's computer screen listing any existing orders in the system, along with the user name associated with this session. If the order is incomplete, the user may select the order and continue the process from the stage of layout preview, as per block 52. If the order has been submitted, the user may select the order to review the current order status. The user may logout from the current account and login to a different account or create a new account at any time. Also, returning users with accounts are recognized by the server 12 and welcomed by username when they start a session. If the user is logged on and abandons the novice order creation subsystem 16 at any stage before it is complete, all design information is preserved in the system 10, and is available next time the user logs on to that account. Should a non-logged on user wish to abandon the novice order creation subsystem 16 and return later on to continue therewith, the status of the user's design is preserved in the system 10 and referenced by use of a cookie on the user's computer, and the user may recommence from where the user left off when the user returns to the online system 10.

The select image stage, as per block 50, of the subsystem 16 involves the user or online novice customer 36 selecting an image from a library of offered images from the system database in the server 12. The online novice order is not considered to have been “started” and will not be linked to the account as an incomplete order should the user abandon the process until at least an image has been selected. Several screens guide the user through the process of selecting an image. The main page displays a list of all image categories. The user may click on any category to link to the set of images in that category. The set of images in a category are displayed to the user on a series of pages. A number of images are displayed in a grid on each page, with links to the subsequent and preceding pages in the set. The following information is displayed for each image: thumbnail image and title. When the user selects a particular image from the result set page, an image detail page is displayed showing the following information on the image: the full-sized preview image, title and optional descriptive text.

The select and preview layout, as per block 52, of the subsystem 16 provides a means of defining, previewing and refining the format and layout of the postcard. The user must be able to randomly access and modify any of these settings. The user may change the currently selected image at any time. The user also may change the back-of-postcard template at any time, but doing so will discard all template field text settings. The following information defines the postcard front: selected image, is headline required?, headline text, headline font, and headline color. A graphical preview of the front of the postcard, displaying the selected image at full size is shown to the user. The user is able to select headline options. The preview is updated to reflect the settings as they are made by the user. The following information defines the postcard back: back of postcard template, selected font, text for each template field, and optional text describing any special requirements. To layout the back of the postcard, the user selects a template defining the back of the postcard layout. Thumbnails of all available templates are displayed on a selection page. When a thumbnail is selected, a full-sized graphical preview of the back of the postcard, displaying sample text in each template text field, is displayed. A list of available fonts is displayed for the user to select from. The user is able to enter text for each template field. The preview is updated to display the text for each field as it is entered, and font selection if it is changed. The user may additionally enter text describing any special requirements.

The enter order data stage, as per block 54, of the subsystem 16 involves the novice customer 36 entering order and billing details in order for such user to lodge the online order. Costs relating to selected layout options are displayed to the user, along with the quantity and size options and costs for the user to select from. The user must select: order quantity and product size/type. The user must login now by following the steps described previously. Also, the customer's shipping and billing details must be provided. If the customer has previously completed an order details form, defaults are available for all of these fields, recorded from the last time the user entered them. These fields are: customer name; billing address, city, state and zip code; shipping address, city, state and zip code; home, office and fax phone numbers; and payment type. If the payment type selected is a credit card, and the customer has previously entered credit card details, details are displayed of each credit card the user has previously given (with only the last 4 digits of the credit card number visible). The user may select the credit card the user wishes to bill this order to, or enter the details of a new credit card. The following credit card details are required to bill the order to a credit card: credit card type; credit card number; expiration date; and name of the credit card holder. The order summary is displayed to the user as follows: job number allocated to this order; customer name and number; order quantity, product size and type; shipping address; total order cost; and payment type. The user reviews and agrees to accept terms and conditions of the transaction. Also, the customer must confirm the order and conditions.

Referring to FIG. 3, there is illustrated the sequence of stages addressed by a professional customer 38 in using the professional order creation subsystem 18 of the online system 10. The professional customer 38 will submit an order using the professional order creation subsystem 18. This subsystem 18 involves the professional customer 38 submitting press-ready artwork, rather than selecting artwork from the library in the database of the site server 12. The user login, as per block 56, is carried out substantially the same as described earlier in connection with the novice order creation subsystem 16. The sequence of stages of the professional order creation subsystem 18 includes, first, provide directions, as per block 58, next, enter order details, as per block 60, and, finally, either file upload, as per block 62, or manual file submission, as per block 64.

In view that the professional user or customer 38 must submit the press-ready artwork that the user wishes to have used in the order, the provide directions stage, as per block 58, of the subsystem 18 requires the professional user to submit information directions and instructions regarding the intended submission. The user may indicate after logging in that the user wishes to resubmit files for an existing order. If such be the case, then submission instructions are displayed. Otherwise, the following information must be elicited from the user: computer type (Mac or Windows); and selected submission method, either file upload stage, as per block 62, or manual submission stage, as per block 64, of subsystem 18. The user is then presented with a list of formats and preconditions that the user's artwork must meet in order to be processed. Links for instructions to correctly format the user's files using a variety of applications are displayed to the user. A preflight checklist is displayed to the user. Each point must be checked before the user may continue.

The enter order details stage, as per block 60, of the subsystem 18 is carried out substantially the same as described earlier in connection with the novice order creation subsystem 16. The file upload stage, as per block 62, and the manual file submission stage, as per block 64, of the subsystem 18 have been discussed above. The user submits the file the user wishes to be used in the professional order using FTP. This process does not directly involve the online system 10. The manual file submission is an offline process, not involving the online system 10.

Referring again to FIG. 1, the order tracking subsystem 20 of the online system 10 allows the customers 32 to able to view online the status of all orders that they have submitted to the online system 10. The user selects “view order status” and in response the customer number and job number is requested from the user. Instructions are available explaining how this information can be found. The online system 10 finds the matching order. If no such match is found, an error message is displayed. The following order status information is displayed for the selected order: order description; order details; current status of the order; and customer service contact information.

Referring still to FIG. 1, the administrative control subsystem 22 of the online system 10 allows internal staff of the company providing the online system 10 to view, report and edit data in the database of the online site server 12. The tasks performed by the administrator 34 relate to order reporting and customer administration.

With respect to order reporting, the database has information stored for each order. This information includes: an identifying job number; configured novice subsystem preview; selected size and type; selected quantity; customer associated with this order; and billing details. The administrator 34 is able to view order details by selecting a specific order from the result set of orders matching the selected criteria.

With respect to customer administration, the administrative control subsystem 22 provides a means for viewing, browsing and search customer account data. Information associated with each customer includes: username; customer number; company name; email address; work phone number; fax number & note; address, city, state and zip code for billing address; address, city, state and zip code for shipping address; credit card details; whether user wishes to receive mailings; notes about this customer; and orders for this customer. The administrator 34 is able to find a list of orders matching the following criteria: username; customer number; job number; and email address. The administrator 34 is able to view customer details by selecting a specific customer from the result set of customers matching the selected criteria. The administrator 34 is able to edit the following customer fields: username; customer name; company name; email address; work phone number; fax number & note; address, city, state and zip code for billing address; address, city, state and zip code for shipping address; whether the user wishes to receive mailings; and notes about this customer.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

I claim:

1. An online postcard order and creation system, comprising:
(a) an online site server;
(b) a user login subsystem by which a novice customer creates an account and logs into the online site server;
(c) a novice order creation subsystem accessible and employed by a logged-in novice customer who chooses to place an order and create a postcard online by selecting an image from a database in the online site server having a library of offered images; and
(d) an order tracking subsystem which is accessible by a novice customer to view the status of a submitted order.

2. The system of claim 1 wherein the novice customer further chooses to place the order and create the postcard online by selecting and previewing a layout of the postcard front and back.

3. The system of claim 2 wherein the novice customer still further chooses to place the order and create the postcard online by entering the customer order and billing details for the created postcard into the online site server.

4. The system of claim 1 wherein the novice customer still further chooses to place the order and create the postcard online by entering the customer order and billing details for the created postcard into the online site server.

5. The system of claim 4 further comprising:
an administrative control subsystem which allows internal staff to view, report and edit novice customer orders and account data stored in the online site server and employed in the operation of the novice order creation subsystem.

6. The system of claim 1 further comprising:
an administrative control subsystem which allows internal staff to view, report and edit novice customer orders and account data stored in the online site server and employed in the operation of the novice order creation subsystem.

7. An online postcard order and creation system, comprising:
(a) an online site server;
(b) a user login subsystem by which a professional customer creates an account and logs into the online site server;
(c) a professional order creation subsystem accessible and employed by a logged-in customer who chooses to place an order and create the postcard by submitting press-ready artwork of the postcard; and
(d) an order tracking subsystem which can be accessed by a professional customer to view the status of a submitted order.

8. The system of claim 7 wherein the press-ready artwork is submitted by the professional customer via File Transfer Protocol.

9. The system of claim 8 wherein the professional customer chooses to place an order and create the postcard by entering customer order and billing details for the created postcard into the online site server.

10. The system of claim 7 wherein the professional customer chooses to place an order and create the postcard by entering customer order and billing details for the created postcard into the online site server.

11. The system of claim 10 further comprising:
an administrative control subsystem which allows internal staff to view, report and edit customer orders and account data stored in the online site server and employed in the operation of the order creation subsystem.

12. The system of claim 7 further comprising:
an administrative control subsystem which allows internal staff to view, report and edit customer orders and account data stored in the online site server and employed in the operation of the order creation subsystem.

13. An online postcard order and creation system, comprising:
(a) an online site server;
(b) a user login subsystem by which customers create their accounts and logs into the online site server;
(c) a novice order creation subsystem accessible and employed by a logged-in novice customer who chooses to place an order and create a postcard online by selecting an image from a database in the online site server having a library of offered images;
(d) a professional order creation subsystem accessible and employed by a logged-in customer who chooses to place an order and create the postcard by submitting press-ready artwork of the postcard; and
(e) an order tracking subsystem which can be accessed by a customer to view the status of a submitted order.

14. The system of claim 13 wherein the novice customer further chooses to place the order and create the postcard online by selecting and previewing a layout of the postcard front and back.

15. The system of claim 14 wherein the novice customer still further chooses to place the order and create the postcard online by entering the customer order and billing details for the created postcard into the online site server.

16. The system of claim 15 further comprising:
an administrative control subsystem which allows internal staff to view, report and edit customer orders and account data stored in the online site server and employed in the operation of the order creation subsystem.

17. The system of claim 13 wherein the press-ready artwork is submitted by the professional customer via File Transfer Protocol format.

18. The system of claim 17 wherein the professional customer chooses to place an order and create the postcard by entering customer order and billing details for the created postcard into the online site server.

19. The system of claim 18 further comprising:
an administrative control subsystem which allows internal staff to view, report and edit customer orders and account data stored in the online site server and employed in the operation of the order creation subsystems.

20. The system of claim 13 further comprising:
an administrative control subsystem which allows internal staff to view, report and edit customer orders and account data stored in the online site server and employed in the operation of the order creation subsystems.
